(19) United States
(12) Patent Application Publication
(10) Pub. No.: US 2010/0141866 A1
(43) Pub. Date: Jun. 10, 2010

(54) LIGHT EMISSION DEVICE AND DISPLAY DEVICE USING THE LIGHT EMISSION DEVICE AS A LIGHT SOURCE

(76) Inventors: Kyung-Sun Ryu, Suwon-si (KR); Hyeong-Rae Seon, Suwon-si (KR); Dong-Su Chang, Suwon-si (KR)

Correspondence Address: CHRISTIE, PARKER & HALE, LLP, PO BOX 7068, PASADENA, CA, 91109-7068, US

(21) Appl. No.: 12/614,327

(22) Filed: Nov. 6, 2009

Related U.S. Application Data
(60) Provisional application No. 61/119,977, filed on Dec. 4, 2008.

(51) Int. Cl. G02F 1/13357; H01J 1/54; G09F 13/08

(52) U.S. Cl. 349/61; 313/495; 362/97.1

(57) ABSTRACT

A light emission device including an electron discharger including a first substrate, a plurality of cathode electrodes, a plurality of electron emission regions, and a plurality of gate electrodes, the first substrate having a plurality of recessed portions at a first surface of the first substrate, the cathode electrodes extending along a first direction and in the recessed portions, the electron emission regions on the cathode electrodes, and the gate electrodes extending along a second direction crossing the first direction; a light emitter including a second substrate, the second substrate having a second surface facing the first surface of the first substrate with a gap therebetween; and a plurality of fixing blocks on the first substrate and between the gate electrodes, the fixing blocks being separated from the light emitter.

### CROSS-REFERENCE TO RELATED APPLICATION

This application claims priority to and the benefit of U.S. Provisional Patent Application No. 61/119,977 filed, Dec. 4, 2008, the entire content of which is incorporated herein by reference.

### BACKGROUND OF THE INVENTION

1. Field of the Invention

The present invention relates to a light emission device. More particularly, the present invention relates to an electron emission unit of a light emission device. Furthermore, the present invention relates to a display having a light emission device.

2. Description of the Related Art

A light emission device typically has a front substrate on which a phosphor layer and an anode electrode are formed and a rear substrate on which electron emission regions and driving electrodes are formed. The peripheries of the front and rear substrates are bonded together by a sealing member to form a sealed interior space, and then the interior space is exhausted, thereby forming a vacuum vessel.

Typically, driving electrodes of the light emission device include cathode electrodes and gate electrodes. The gate electrodes are located on the cathode electrodes and are formed in a direction crossing the cathode electrodes. Electron emission regions are formed at the intersection of the cathode electrodes and the gate electrodes. The driving electrodes and the electron emission regions constitute the electron emission unit.

The electron emission unit of the above structure is complicated to manufacture, and it is very important to align members sequentially formed in each manufacturing step. Thus, in order to check this, additional labor is required, which takes a lot of time and cost in manufacturing.

The above information disclosed in this Background section is only for enhancement of understanding of the background of the invention, and therefore it may contain information that does not form the prior art that is already known in this country to a person of ordinary skill in the art.

### SUMMARY OF THE INVENTION

An aspect of an embodiment of the present invention is directed toward a light emission device, which can simplify the manufacturing process by improving a structure of an electron emission unit, reducing manufacturing costs, and increasing driving stability by improving the withstand voltage characteristics of cathode electrodes and gate electrodes, and a display using the light emission device as a light source.

Another aspect of an embodiment of the present invention provides a light emission device, which can prevent an electrical short circuit between the gate electrodes and ease the alignment of the gate electrodes, and a display using the light emission device as a light source.

A light emission device according to an exemplary embodiment of the present invention includes an electron discharger including a first substrate, a plurality of cathode electrodes, a plurality of electron emission regions, and a plurality of gate electrodes, the first substrate having a plurality of recessed portions at a first surface of the first substrate, the cathode electrodes extending along a first direction and in the recessed portions, the electron emission regions on the cathode electrodes, and the gate electrodes extending along a second direction crossing the first direction; a light emitter including a second substrate, the second substrate having a second surface facing the first surface of the first substrate with a gap therebetween; and a plurality of fixing blocks on the first substrate and between the gate electrodes, the fixing blocks being separated from the light emitter.

The light emitter may further include a light emission unit on the second surface of the second substrate and spatially separated from the fixing blocks.

Each of the gate electrodes may have a mesh structure with a plurality of openings formed therein.

The gate electrodes may be partially fixed to the first substrate by a sealing member.

In one embodiment, the light emission device further includes a sealing member between the first substrate and the second substrate, the sealing member defining a vacuum vessel with the first substrate and the second substrate, each of the gate electrodes including: a first edge portion located outside the vacuum vessel; and a second edge portion located inside of the vacuum vessel.

At least one of the fixing blocks may be located adjacent to the second edge portion.

In another embodiment, the light emission device includes a sealing member between the first substrate and the second substrate, each of the gate electrodes including: a first edge portion on the first substrate and fixed to the first substrate by a compression force of the sealing member on the first edge portion; and a second edge portion on the first substrate and located away from the sealing member.

At least one of the fixing blocks may be in contact with the second edge portion.

The gate electrodes may have an inter-electrode gap therebetween, and each of the fixing blocks may have a width substantially identical to the inter-electrode gap.

The gate electrodes may have an inter-electrode gap therebetween, and each of the fixing blocks may have a width smaller than the inter-electrode gap.

Each of the fixing blocks may have a specific resistance between about 10⁸ to about 10¹² Ωcm.

Each of the fixing blocks may be fixed to the first surface of the first substrate by a frit glass adhesive layer.

The first substrate may have a plurality of grooves located at positions corresponding to the fixing blocks, and the fixing blocks may be fitted into the grooves.

The light emission device may further include a connection portion for integrally connecting the fixing blocks.

Each of the recessed portions may have a depth (D); each of the cathode electrodes may have a first thickness; each of the electron emission regions may have a second thickness; and the depth may be larger than a sum of the first thickness and the second thickness.

The light emission device may further include a plurality of spacers between the electron discharger and the light emitter to withstand a compression force and to maintain the gap between the first surface of the first substrate and the second surface of the second substrate.

A light emission device according to another exemplary embodiment of the present invention includes a light emission device for emitting a light; and a display panel for receiving the light emitted from the light emission device to display images, the light emission device including: an electron discharger including a first substrate, a plurality of cathode electrodes, a plurality of electron emission regions, and a plurality of gate electrodes, the first substrate having a plurality of recessed portions at a first surface of the first substrate, the cathode electrodes extending along a first direction and in the recessed portions, the electron emission regions on the cathode electrodes, and the gate electrodes extending along a second direction crossing the first direction; a light emitter including a second substrate, the second substrate having a second surface facing the first surface of the first substrate with a gap therebetween; and a plurality of fixing blocks on the first substrate and between the gate electrodes, the fixing blocks being separated from the light emitter.

The light emitter may further include a light emission unit on the second surface of the second substrate and spatially separated from the fixing blocks.

Each of the gate electrodes may have a mesh structure with a plurality of openings formed therein.

The display panel may include a plurality of first pixels; the light emission device may include a plurality of second pixels, the second pixels being less in number than the first pixels; and each of the second pixels may be configured to independently emit light in response to a gray level of corresponding ones of the first pixels.

The display panel may be a liquid crystal panel.

In an exemplary embodiment of the present invention, a light emission device includes: a first substrate and a second substrate that are disposed facing each other;

recessed portions formed on one surface of the first substrate; cathode electrodes formed at the recessed portions; electron emission regions disposed on the cathode electrodes; gate electrodes fixed to one surface of the first substrate along a direction crossing the cathode electrodes, and formed of a mesh structure having openings formed therein; fixing blocks disposed on one surface of the first substrate between the gate electrodes, and having a height smaller than the gap between the first and second substrates; and a light emission unit located on one surface of the second substrate.

The light emission device may further include a sealing member disposed between the first and second substrates, and each of the gate electrodes may include a first edge portion located inside of the sealing member and a second edge portion located outside of the sealing member. The fixing blocks may be disposed around the second edge portion.

Each of the fixing blocks may have a width identical to or smaller than the gap between the gate electrodes. Each of the fixing blocks may have a specific resistance of 10⁸ to 10¹² Ωcm.

Each of the fixing blocks may be fixed to one surface of the first substrate by a frit glass adhesive layer. Alternatively, grooves may be formed at a position where the first substrate corresponds to the fixing blocks, and the fixing blocks may be fitted to the grooves.

The light emission device may further include a connection portion for integrally connecting the fixing blocks. The connection portion may be fixed to either one side surface or an upper surface of the fixing blocks.

In another exemplary embodiment of the present invention, a display includes: a light emission device; and a display panel located in front of the light emission device to thereby receive the light emitted from the light emission device to display images. The light emission device includes: a first substrate and a second substrate that are disposed facing each other; recessed portions formed on one surface of the first substrate; cathode electrodes formed at the recessed portions; electron emission regions disposed on the cathode electrodes; gate electrodes fixed to one surface of the first substrate along a direction crossing the cathode electrodes, and formed of a mesh structure having openings formed therein; fixing blocks disposed on one surface of the first substrate between the gate electrodes, and having a height smaller than the gap between the first and second substrates; and a light emission unit located on one surface of the second substrate.

The display panel may have first pixels and the light emission device may have second pixels, wherein the number of the second pixels may be less than the number of the first pixels, and the second pixels may emit light independently in response to the gray level of the corresponding first pixels. The display panel may be a liquid crystal panel.

In the exemplary embodiments of the present invention, driving can be stabilized by increasing the withstand voltage characteristics of the cathode electrodes and gate electrodes, and high luminance can be achieved by increasing the anode voltage. In addition, since a thick film process for forming an insulation layer and a thin film process for forming gate electrodes may be omitted, the manufacturing process of the light emission device can be simplified, and the manufacturing costs can be reduced.

Moreover, as the fixing blocks mechanically separate the gate electrodes from each other, the neighboring gate electrodes are prevented from contacting one other, thereby preventing an electrical short circuit of the gate electrodes and a resulting driving failure. Particularly, the fixing blocks are firstly fixed to the first substrate, and the gate electrodes are disposed between the fixing blocks, to thus make easier the alignment of the gate electrodes.

### BRIEF DESCRIPTION OF THE DRAWINGS

FIG. 1 is a schematic perspective view of a light emission device according to a first embodiment of the present invention.

FIG. 2 is a schematic cross-sectional view of the light emission device according to the first embodiment of the present invention.

FIG. 3 is a schematic plan view showing a first substrate, gate electrodes, and a sealing member of the light emission device shown in FIG. 1.

FIG. 4A is a schematic cross-sectional view showing the first substrate and fixing blocks of the light emission device according to an embodiment of the present invention.

FIG. 4B is a schematic cross-sectional view showing the first substrate and fixing blocks of the light emission device according to another embodiment of the present invention.

FIG. 5 is a schematic cross-sectional views showing the first substrate and fixing blocks of the light emission device according to another embodiment of the present invention.

FIG. 6 is a schematic perspective view showing gate electrodes and fixing blocks of the light emission device according to a second embodiment of the present invention.

FIG. 7 is a schematic perspective view showing gate electrodes and fixing blocks of the light emission device according to a third embodiment of the present invention.

FIG. 8 is a schematic exploded perspective view of a display according to an embodiment of the present invention.

FIG. 9 is a schematic cross-sectional view of the display panel shown in FIG. 8.

### DETAILED DESCRIPTION OF THE EMBODIMENTS

Hereinafter, the present invention will be described more fully with reference to the accompanying drawings, in which exemplary embodiments of the invention are shown. As those skilled in the art would realize, the described embodiments may be modified in various different ways, all without departing from the spirit or scope of the present invention.

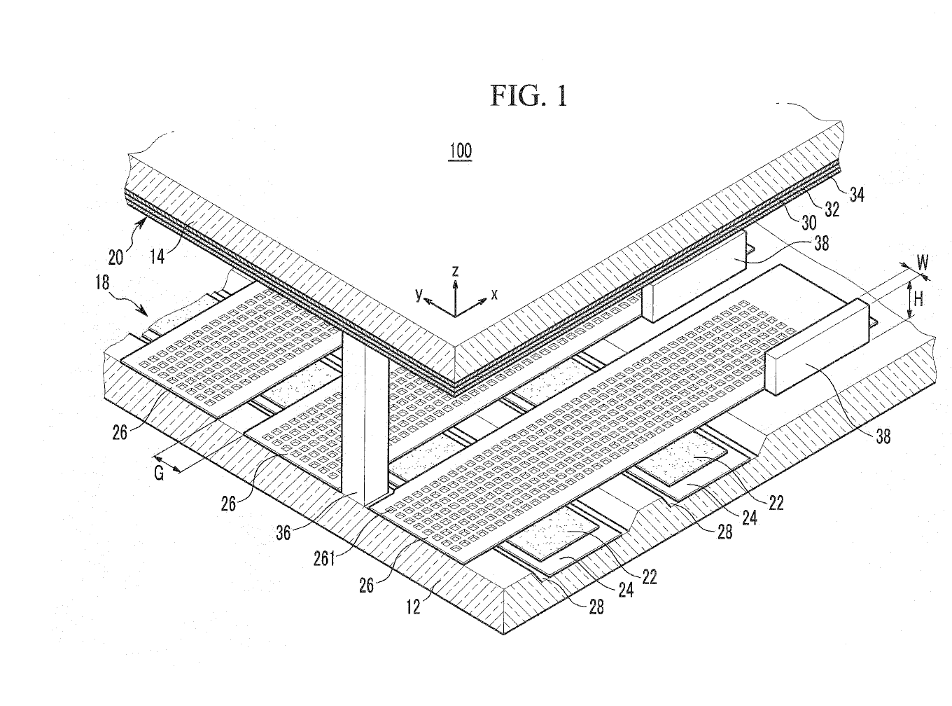

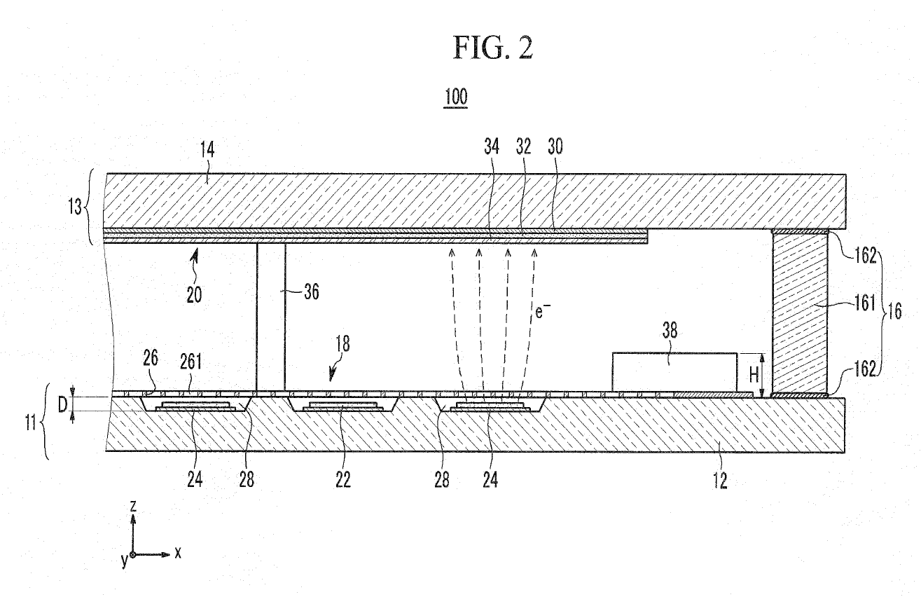

FIG. 1 and FIG. 2 are, respectively, a schematic perspective view and a schematic cross-sectional view of a light emission device according to a first embodiment of the present invention.

Referring to FIGS. 1 and 2, a light emission device 100 of this embodiment includes an electron discharger 11 and a light emitter 13 that are disposed facing each other. The electron discharger 11 includes a first substrate 12, a plurality of cathode electrodes 24, a plurality of electron emission regions 22, and a plurality of gate electrodes 26. The light emitter 13 includes a second substrate 14 and a light emission unit 20. A sealing member 16 is provided at the peripheries of the first and second substrates 12 and 14 to seal them together, and thus form a vacuum vessel. The interior of the sealed vessel is exhausted to be kept to a degree of vacuum of about 10⁻⁶ Torr.

Of the first and second substrates 12 and 14, the areas disposed inside of the sealing member 16 are divided into an active region substantially contributing to the emission of visible light and an inactive area surrounding the active region. An electron emission unit 18 for emitting electrons is provided at the active area of the first substrate 12 and a light emission unit 20 for emitting the visible light is provided at the active area of the second substrate 14. The second substrate 14, on which the light emission unit 20 is located, may be a front substrate of the light emission device 100.

The electron emission unit 18 includes electron emission regions 22 and driving electrodes for controlling an electron emission amount of the electron emission regions 22. The driving electrodes include cathode electrodes 24 that are formed in a stripe pattern extending in a first direction (e.g., the y-axis direction of FIG. 1) on the first substrate 12 and gate electrodes 26 that are formed in a stripe pattern extending in a second direction (e.g., the x-axis direction of FIG. 1) crossing the first direction above the cathode electrodes 24.

In this embodiment, recessed portions 28 having a depth D, which may be predetermined, (see FIG. 2) are formed on an inner surface of the first substrate 12 facing the second substrate 14 so that the cathode electrodes 24 are located on the bottom surfaces of the recessed portions 28. The recessed portions 28 may be formed by removing part of the first substrate 12 by a method such as etching or sand blasting, and are formed in a stripe pattern in the length direction of the cathode electrodes 24.

The recessed portion 28 may have vertical side walls or sloped side walls. FIGS. 1 and 2 illustrate one example in which the recessed portions 28 have sloped side walls. The thickness of the first substrate 12 may be about 1.8 mm, the depth D of the recessed portions 28 may be about 40 μm, and the maximum width of the recessed portions may be about 300 to 600 μm.

The cathode electrodes 24 located on the bottom surfaces of the recessed portions 28, as seen from above, are located below the upper surface (i.e., the inner surface of the first substrate 12 where no recessed portion is formed) of the first substrate 12 by a height difference, which may be predetermined. Regions of the first substrate 12 located between the recessed portions 28 form relatively protruding portions, and these protruding portions function as a barrier for separating the neighboring cathode electrodes 24 from each other.

The electron emission regions 22 may be formed on the cathode electrodes in a stripe pattern parallel to the cathode electrodes 24. Alternatively, the electron emission regions 22 may be partially formed on the cathode electrodes 24, so that the electron emission regions 22 correspond to crossing regions of the cathode electrodes 24 and the gate electrodes 26. FIG. 1 illustrates one example in which the electron emission regions 22 are formed in a stripe pattern.

The electron emission regions 22 are formed of materials, such as carbon materials or nanometer (nm) size materials, which emit electrons when an electric field is applied in a vacuum. The electron emission regions 22 may include, for example, carbon nanotube, graphite, graphite nanofiber, diamond-like carbon, silicon nanowire or combinations thereof.

The electron emission regions 22 may be formed by a thick film process, such as screen printing. That is, the electron emission regions 22 may be formed by the process of: \textcircled{1} screen-printing a paste-phased mixture containing an electron emission material on the cathode electrodes 24; \textcircled{2} drying and firing the printed mixture; \textcircled{3} activating the surface of the electron emission regions 22 so as to expose the electron emission material to the surface of the electron emission regions 22.

The surface activation process may be performed by an operation of attaching an adhesive tape onto the first substrate 12 and then removing it, which is carried out before fixing the gate electrodes 24 onto the first substrate 12. Through the surface activation process, part of the surface of the electron emission regions 22 may be removed and electron emission materials, such as carbon nanotube, may be raised substantially vertically to the surface of the electron emission regions 22.

As the depth D of the recessed portions 28 is larger than the sum of the thickness of the cathode electrodes 24 and the thickness of the electron emission regions 22, the electron emission regions 22, too, are located below the upper surface of the first substrate 12, with a height difference, which may be predetermined.

The cathode electrodes 24 are formed through a suitable thin film process or a suitable thick film process. On the other hand, the gate electrodes 26 are formed of a metal plate having a thickness, which may be predetermined, and a mesh structure having openings 261 formed therein for passing an electron beam therethrough. For example, the gate electrodes 26 may be manufactured by the steps of cutting a metal plate having a given size into a stripe shape and then forming openings 261 in the metal plate by a method such as etching.

The gate electrodes 26 may have openings 261 at regions between the cathode electrodes 24, i.e., regions facing the first substrate 12, as well as regions facing the cathode electrodes 24, with respect to a state in which the gate electrodes 26 having the openings 261 are installed on the first substrate 12.

The gate electrodes 26 of this type, excluding both opposite edge portions, form a mesh structure. In this case, the alignment with the cathode electrodes 24 need not be considered when fixing the gate electrodes 26 onto the first substrate 12. The gate electrodes 26 may be made of a nickel-iron alloy or other metal material, and may have a thickness of about 50 μm and a width of about 10 mm.

The gate electrodes 26 are fixed to the upper surface of the first substrate 12 in a direction crossing the cathode electrodes 24, with a distance therebetween. As the cathode electrodes 24 and the electron emission regions 22 are located in the recessed portions 28 of the first substrate 12, insulation between the cathode electrodes 24 and the gate electrodes 26 can be achieved by fixing the gate electrodes 26 to the upper surface of the first substrate 12.

In the above-described structure, one of the crossing areas of the cathode electrodes 24 and the gate electrodes 26 may correspond to one pixel area of the light emission device 100, or two or more of the crossing areas may correspond to one pixel area of the light emission device 100. In the latter case, the cathode electrodes 24 located in the same pixel are applied with the same driving voltage, and the gate electrodes 26 located in the same pixel are also applied with the same driving voltage.

Next, the light emission unit 20 includes an anode electrode 30 formed on an inner surface of the second substrate 14, a phosphor layer 32 located on one surface of the anode electrode 30, and a reflection layer 34 covering the phosphor layer 32.

The anode electrode 30 is formed of a transparent conductive material, such as indium tin oxide (ITO) so that visible light emitted from the phosphor layer 32 can transmit through the anode electrode 30. The anode electrode 30 is an acceleration electrode that receives a high voltage (i.e., anode voltage) of thousands of volts or more to place the phosphor layer 32 at a high potential state so as to attract an electron beam.

The phosphor layer 32 may be formed of a mixture of red, green, and blue phosphors, which can collectively emit white light. The phosphor layer 32 may be formed on the entire active area of the second substrate 14, or may be divided into a plurality of sections corresponding to the pixel areas. FIG. 1 and FIG. 2 illustrate a case where the phosphor layer 32 is formed on the entire active area of the second substrate 14.

The reflection layer 34 may be an aluminum layer having a thickness of about several thousands of angstroms (Å) and including a plurality of tiny holes for passing an electron beam. The reflection layer 34 functions to enhance the luminance of the light emission device 100 by reflecting the visible light, which is emitted from the phosphor layer 32 to the first substrate 12, toward the second substrate 14. The anode electrode 30 described above can be eliminated, and the reflection layer 34 can function as the anode electrode by receiving the anode voltage.

Disposed between the first and second substrates 12 and 14 at the active area are spacers 36 that are able to withstand a compression force applied to the vacuum vessel and to uniformly maintain a gap between the first and second substrates 12 and 14 (specifically, a gap between the electron discharger 11 and the light emitter 13). The spacers 36 are located corresponding to the positions between the gate electrodes 26.

The light emission device 100 of the above-described structure is driven when a scan driving voltage is applied to either the cathode electrodes 24 or the gate electrodes 26, a data driving voltage is applied to the other electrodes 24 or 26, and an anode voltage of thousands of volts or more is applied to the anode electrode 30.

Electric fields are formed around the electron emission regions 22 at the pixels where the voltage difference between the cathode and gate electrodes 24 and 26 is greater than a threshold value, and thus electrons are emitted from the electron emission regions 22. The emitted electrons, attracted by the anode voltage applied to the anode electrode 30, collide with a corresponding portion of the phosphor layer 32, thereby exciting the phosphor layer 32. A luminance of the phosphor layer 32 for each pixel corresponds to an electron beam emission amount of the corresponding pixel.

In the above-described driving process, as the gate electrodes 26 are disposed directly above the electron emission regions 22, electrons emitted from the electron emission regions 22 pass through the openings 261 of the gate electrodes and then reach the phosphor layer 32, with the beam diffusion of the electrons being reduced. Accordingly, the light emission device 100 of this exemplary embodiment can effectively suppress the charging of electric charges on the side walls of the recessed portions 28 by reducing the initial diffusion angle of the electron beam.

As a result, the light emission device 100 of this exemplary embodiment can stabilize the driving by increasing the withstand voltage characteristics of the cathode electrodes 24 and the gate electrodes 26, and can achieve high luminance by applying a voltage of about 10 kV or more, and preferably, about 10 to 15 kV, to the anode electrode 30.

Additionally, the light emission device 100 of this embodiment can simplify the manufacturing process because a thick film process for forming an insulation layer and a thin film process for forming gate electrodes may be omitted. Further, as described above, it is not necessary to consider the alignment with the cathode electrodes 24 when disposing the gate electrodes 26 on the first substrate, thus making the manufacturing easier.

Moreover, since the gate electrodes 26 are disposed after the electron emission regions 22 are formed, it is possible to avoid the problem of an electrical short of the cathode electrodes 24 and the gate electrodes 26 due to a conductive electron emission material during the formation of the electron emission regions 22, as might have occurred in the conventional art.

In the above-described structure, the gate electrodes 26 may be fixed to the first substrate 12 by the sealing member 16 without any special fixing mechanisms. In addition, the gate electrodes 26 are kept from contacting one another by the fixing blocks 38 to be described in more detail later, thereby preventing an electrical short circuit between the gate electrodes 26.

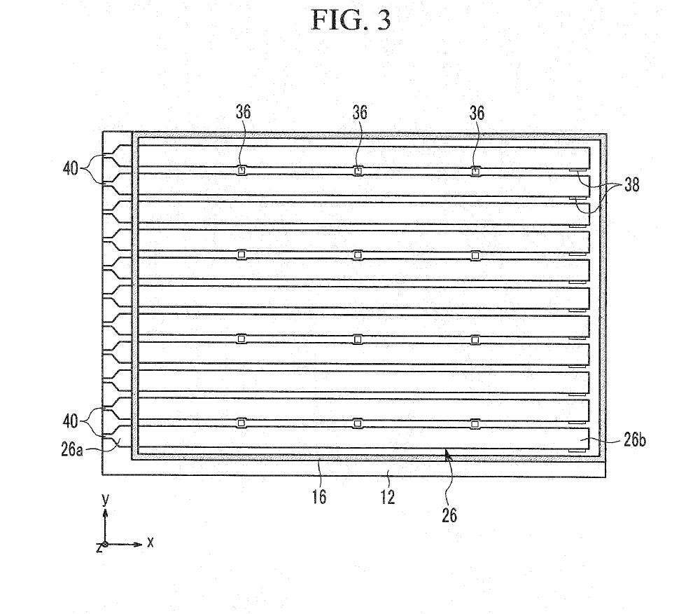

FIG. 3 is a schematic plan view showing a first substrate, gate electrodes, and a sealing member of the light emission device shown in FIG. 1.

Referring to FIG. 3, the gate electrodes 26 are provided with terminal portions 40 for applying a voltage to first edge portions 26a, and the terminal portions 40 are located in parallel along the periphery of the first substrate 12. The sealing member 16 is disposed on the gate electrodes 26 and crossing the gate electrodes 26 so as to expose the terminal portions 40 to outside of the vacuum vessel defined by the sealing member 16. As a result, the gate electrodes 26 are pressed at the first edge portions 26a by the sealing member 16, and fixed to the first substrate 12 by the bonding force and compressing force of the sealing member 16.

The regions of the gate electrodes 26, excluding the terminal portions 40, are located inside the vacuum vessel defined by the sealing member 16. The sealing member 16 may be made entirely of a frit glass adhesive layer, or may be of a lamination structure of a sealing frame made of glass or ceramic and a frit glass adhesive layer. FIG. 2 illustrates one example in which the sealing member 16 includes a sealing frame 161 and a pair of glass frit adhesive layers 162.

In the above-described structure, the first edge portions 26a of the gate electrodes are firmly fixed to the first substrate 12 by being pressed by the sealing member 16, while the opposite second edge portions 26b of the gate electrodes 26 are simply placed on the first substrate 12 without using any pressing means. Thus, in a subsequent process or after the completion of the product, the gate electrodes 26 may be moved or shaken.

In other words, in an embodiment of the present invention, a sealing member 16 is between the first substrate 12 and the second substrate 14. The sealing member 16 defines a vacuum vessel with the first substrate 12 and the second substrate 14. Also, each of the gate electrodes 26 includes a first edge portion 26a located outside the vacuum vessel, and a second edge portion 26b located inside of the vacuum vessel.

In an embodiment of the present invention, at least one of the fixing blocks 38 is located adjacent to the second edge portion 26b.

In another embodiment of the present invention, each of the gate electrodes 26 includes a first edge portion 26a on the first substrate 12, and the gate electrode 26 is fixed to the first substrate 12 by a compression force of the sealing member 16 on the first edge portion 26a. Further, a second edge portion 26b is on the first substrate 12 and is located away from the sealing member 16. At least one of the fixing blocks 38 may be in contact with the second edge portion 26b.

Referring to FIGS. 1 to 3, the fixing blocks 38 are fixed onto the first substrate 12 between the gate electrodes 26 to thus mechanically separate the neighboring gate electrodes 26. The fixing blocks 38 are located in the vicinity of the second edge portions 26b of the gate electrodes 26, and one fixing block 38 is disposed at each of the regions between the gate electrodes 26.

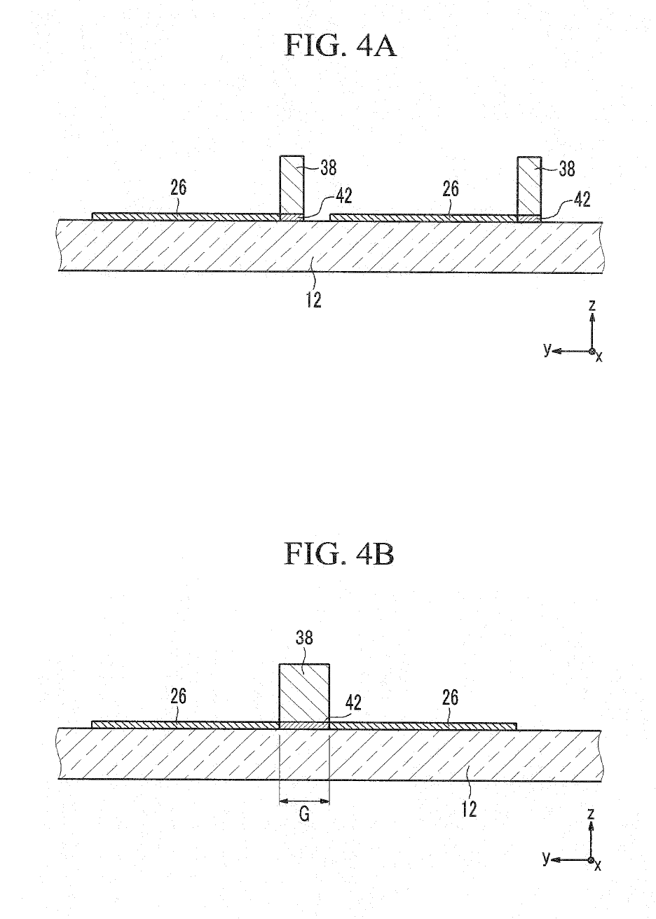

Each of the fixing blocks 38 may have a width W smaller than the gap G (see FIG. 1) between the gate electrodes 26 or a width identical to the gap G between the gate electrodes 26 (see FIG. 4B). In the former case, even when the second edge portions 26b of the gate electrodes 26 are partially moved or shaken, the gate electrodes 26 are kept from contacting each other by the fixing blocks, thereby preventing an electrical short circuit. In the latter case, the gate electrodes 26 are suppressed from being moved or shaken by the fixing blocks 38.

FIGS. 1 and 3 illustrate one example in which the fixing blocks 38 have a width W smaller than the gap G between the gate electrodes 26.

Each of the fixing blocks 38 has a height H (see FIGS. 1 and 2) smaller than the gap between the electron discharger 11 and the light emitter 13. Thus, the fixing blocks 38 do not come into contact with the light emitter 13, and, as a result, no vacuum compression force is applied to the fixing blocks 38. Consequently, damage to the fixing blocks 38 can be reduced, such as breakage or slipping in a subsequent process.

The fixing blocks 38 may be made of an insulation material, such as glass or ceramic, and may be formed in various shapes, such as a rectangular parallelepiped, a regular hexahedron, or a cylinder. Further, as a resistance layer is formed on outer surfaces of the fixing blocks 38, the fixing blocks 38 may have a specific resistance between 10⁸ and 10¹² Ωcm. Thus, no electrical charges are charged on the surfaces of the fixing blocks 38 during the operation of the light emission device 100, thereby suppressing the occurrence of electron beam distortion around the fixing blocks 38.

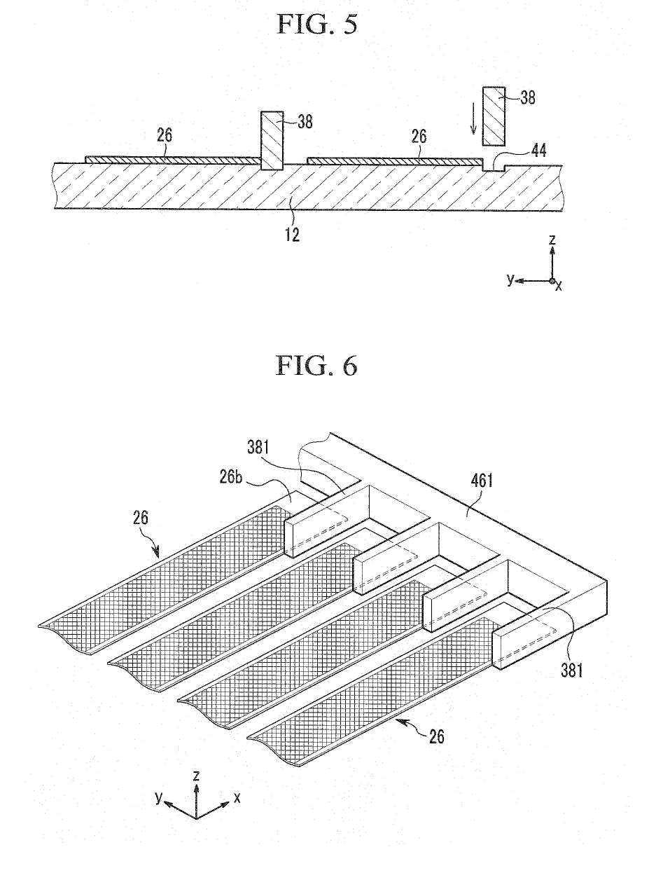

As shown in FIG. 4A, the above-described fixing blocks 38 may be fixed to the first substrate 12 by the frit glass adhesive layer 42. Alternatively, as shown in FIG. 5, the fixing blocks 38 may be fitted to the grooves 44 formed on the first substrate 12 and be fixed to the first substrate 12.

Like above, as the fixing blocks 38 are located at the second edge portions of the gate electrodes 26, the light emission device 100 of this embodiment reduces the neighboring gate electrodes from contacting one other, thereby preventing an electrical short circuit of the gate electrodes and a resulting driving failure. Further, the alignment of the gate electrodes 26 may be made easier by firstly fixing the fixing blocks 38 to the first substrate 12 and then disposing the gate electrodes 26 between the fixing blocks 38.

The spacers 36 also function to mechanically separate the gate electrodes 26. As the fixing blocks 38 can separate the gate electrodes 26 completely, the number of the spacers 36 located in the active area may be reduced.

FIG. 6 is a schematic perspective view showing gate electrodes and fixing blocks of the light emission device according to a second embodiment of the present invention.

Referring to FIG. 6, the light emission device of this embodiment has the same configuration as the light emission device of the previous first embodiment except for a structure in which one side of the fixing blocks 381 is fixed to the connection portion 461 located in a widthwise direction (e.g., the y-axis direction of FIG. 6) of the gate electrodes 26. Similar or like members to those of the first embodiment are designated by the same reference numerals.

The connection portion 461 may be located outside of the second edge portions 26b of the gate electrodes 26, spaced apart a distance, which may be predetermined, from the gate electrodes 26. As the fixing blocks 381 form an integrated structure with the connection portion 461, the installation of the fixing blocks 381 with respect to the first substrate 12 may be easier.

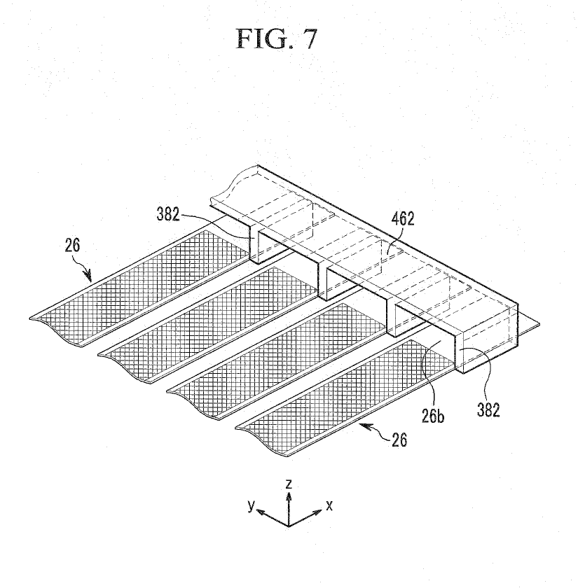

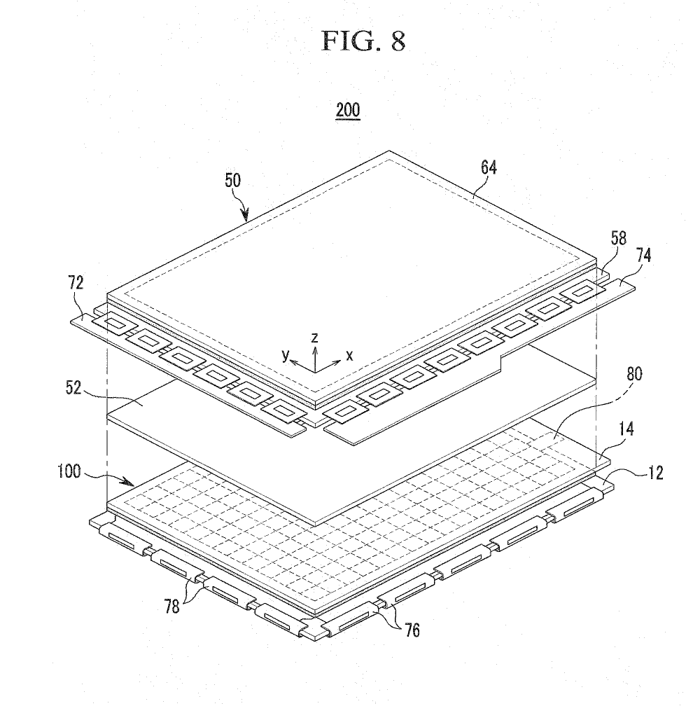

FIG. 7 is a schematic perspective view showing gate electrodes and fixing blocks of a light emission device according to a third embodiment of the present invention.

Referring to FIG. 7, the light emission device of this embodiment has the same configuration as the light emission device of the previous first embodiment except for a structure in which the top portion of the fixing blocks 382 is fixed to the connection portion 462 located in a widthwise direction (e.g., the y-axis direction of FIG. 7) of the gate electrodes 26. Similar or like members to those of the first embodiment are designated by the same reference numerals.

In this embodiment, since the connection portion 462 is located overlapping with part of the gate electrodes 26, the fixing blocks 382 and the connection portion 462 are located in the inactive area. As the fixing blocks 382 form an integrated structure with the connection portion 462, the installation of the fixing blocks 382 with respect to the first substrate 12 may be easier.

FIG. 8 is a schematic exploded perspective view of a display device according to one embodiment of the present invention.

Referring to FIG. 8, a display 200 of this embodiment includes a light emission device 100 and a display panel 50 located in front of the light emission device 100. The light emission device 100 is a light emission device of any one of the previous first to third embodiments, and functions as a light source in the display 200. The display panel 50 may be a transmissive or semi-transmissive liquid crystal display panel. A diffuser 52 for uniformly diffusing light emitted from the light emission device 100 may be located between the light emission device 100 and the display panel 50.

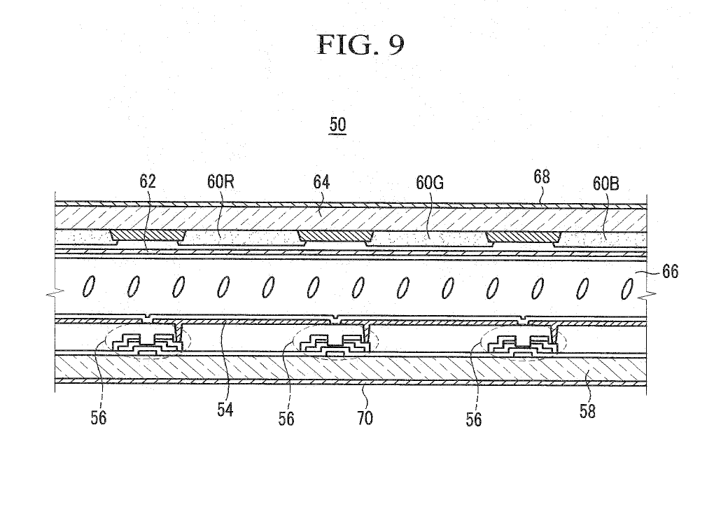

FIG. 9 is a schematic cross-sectional view of the display panel shown in FIG. 8, which illustrates a transmissive liquid crystal display panel by way of example. A description will be made with respect to a case where the display panel 50 is a transmissive liquid crystal display panel with reference to FIG. 9.

Referring to FIG. 9, the display panel 50 includes a lower substrate 58 on which pixel electrodes 54 and thin film transistors 56 are formed, an upper substrate 64 on which color filter layers 60R, 60G, and 60B and a common electrode 62 are formed, and a liquid crystal layer 66 injected between the upper and lower substrates 64 and 58. Polarizing plates 68 and 70 are attached on a top surface of the upper substrate 64 and a bottom surface of the lower substrate 58, respectively, to polarize the light passing through the display panel 50.

The pixel electrode 54 is arranged for each sub-pixel, and the driving of the pixel electrodes 54 is controlled by the thin film transistors 56. The pixel electrodes 54 and the common electrode 62 are formed of a transparent conductive material. The color filter layers 60R, 60G, and 60B include a red filter layer 60R, a green filter layer 60G, and a blue filter layer 60B arranged to correspond to respective sub-pixels.

When the thin film transistor 56 of a specific sub-pixel is turned on, an electric field is formed between the pixel electrode 54 and the common electrode 62. The arrangement angle of liquid crystal molecules is varied by this electric field, and the light transmittance is varied in accordance with the varied arrangement angle. The display panel 50 can control the luminance and color for each pixel by this procedure.

In addition, FIG. 8 illustrates a gate circuit board assembly 72 for transmitting gate driving signals to each of the gate electrodes of the thin film transistors 56, and a data circuit board assembly 74 for transmitting data driving signals to each of the source electrodes of the thin film transistors 56.

The light emission device 100 includes a plurality of pixels, the number of which is less than the number of pixels of the display panel 50 so that one pixel of the light emission device 100 corresponds to two or more pixels of the display panel 50. Each pixel of the light emission device 100 may emit light in response to gray levels of the corresponding pixels of the display panel 50. In one example, each pixel of the light emission device 100 may emit light in response to a highest gray level among gray levels of the corresponding pixels of the display panel 50. The light emission device 100 can represent gray levels of a gray between 2 and 8 bits at each pixel.

For convenience, the pixels of the display panel 50 are referred to as first pixels and the pixels of the light emission device 100 are referred to as second pixels. A group of the first pixels corresponding to one second pixel are referred to as a first pixel group.

In a driving process of the light emission device 100, a signal control unit that controls the display panel 50 \textcircled{1} detects the highest gray level of the first pixel group, \textcircled{2} determines a gray level required for emitting light from the second pixel in response to the detected highest gray level and converts the determined gray level into digital data, \textcircled{3} generates a driving signal of the light emission device 100 using the digital data, and \textcircled{4} applies the generated driving signal to the driving electrodes of the light emission device 100.

The driving signal of the light emission device 100 includes a scan driving signal and a data driving signal. The scan driving signal is applied to the cathode electrodes or the gate electrodes (e.g., the gate electrodes) and the data driving signal is applied to the other electrodes (e.g., the cathode electrodes).

Scan and data circuit board assemblies for driving the light emission device 100 may be located on a rear surface of the light emission device 100. In FIG. 8, first connectors 76 connect the cathode electrodes 24 and the data circuit board assembly, and second connectors 78 connect the gate electrodes 26 and the scan circuit board assembly. A third connector 80 applies anode voltage to the anode electrode 30.

When an image is displayed on the first pixel group, the corresponding second pixel of the light emission device 100 emits light with a gray level, which may be predetermined, by synchronizing with the first pixel group. That is, the light emission device 100 provides light of a high luminance to bright areas of a screen displayed by the display panel 50, and provides light of a low luminance to dark areas thereof. As a result, the display 200 of this embodiment can enhance the contrast ratio of the screen, thereby improving the display quality. To put it in another way, a light emission device includes cathode electrodes and gate electrodes. The gate electrodes are located on the cathode electrodes and are formed in a direction crossing the cathode electrodes. Electron emission regions are formed on the cathode electrodes while interposing a dielectric layer. The gate and cathode electrodes and the electron emission regions constitute the electron emission unit. The electron emission unit of the above structure is complicated to manufacture, and needs to be properly aligned, which takes a lot of manufacturing time and cost.

As such, in view of the above, a light emission device according to an embodiment of the present invention is composed of a first substrate having recessed portions at a first surface of the first substrate. Cathode electrodes are formed to extend along a first direction and in the recessed portions to separate the cathode electrodes from each other. Gate electrodes are disposed and fixed on the first substrate and extending along a second direction crossing the first direction of the cathode electrodes. In addition, fixing blocks are formed on the first substrate and between the gate electrodes to separate the gate electrodes from each other. As such, the fixing blocks ensure the separation between the gate electrodes to thereby protect from an electrical short circuit of the gate electrodes. In addition, the alignment of the gate electrodes may be easier if the fixing blocks are formed on the first substrate before the gate electrodes are formed on the first substrate. Here, each of the fixing blocks has a height smaller than the gap between the first surface of the first substrate and the second surface of the second substrate. Thus, damage to the fixing blocks, such as breakage or slipping in a subsequent process, can be reduced since the fixing blocks do not come into contact with the light emitter.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A light emission device comprising:
an electron discharger comprising a first substrate, a plurality of cathode electrodes, a plurality of electron emission regions, and a plurality of gate electrodes, the first substrate having a plurality of recessed portions at a first surface of the first substrate, the cathode electrodes extending along a first direction and in the recessed portions, the electron emission regions on the cathode electrodes, and the gate electrodes extending along a second direction crossing the first direction;
a light emitter comprising a second substrate, the second substrate having a second surface facing the first surface of the first substrate with a gap therebetween; and
a plurality of fixing blocks on the first substrate and between the gate electrodes, the fixing blocks being separated from the light emitter.

2. The light emission device of claim 1, wherein the light emitter further comprises a light emission unit on the second surface of the second substrate and spatially separated from the fixing blocks.

3. The light emission device of claim 1, wherein each of the gate electrodes have a mesh structure with a plurality of openings formed therein.

4. The light emission device of claim 1, wherein the gate electrodes are partially fixed to the first substrate by a sealing member.

5. The light emission device of claim 1, further comprising a sealing member between the first substrate and the second substrate, the sealing member defining a vacuum vessel with the first substrate and the second substrate, each of the gate electrodes comprising:
a first edge portion located outside the vacuum vessel; and
a second edge portion located inside of the vacuum vessel.

6. The light emission device of claim 5, wherein at least one of the fixing blocks is located adjacent to the second edge portion.

7. The light emission device of claim 1, further comprising a sealing member between the first substrate and the second substrate, each of the gate electrodes comprising:
a first edge portion on the first substrate and fixed to the first substrate by a compression force of the sealing member on the first edge portion; and
a second edge portion on the first substrate and located away from the sealing member.

8. The light emission device of claim 7, wherein at least one of the fixing blocks is in contact with the second edge portion.

9. The light emission device of claim 1, wherein the gate electrodes have an inter-electrode gap therebetween, and each of the fixing blocks has a width substantially identical to the inter-electrode gap.

10. The light emission device of claim 1, wherein the gate electrodes have an inter-electrode gap therebetween, and each of the fixing blocks has a width smaller than the inter-electrode gap.

11. The light emission device of claim 1, wherein each of the fixing blocks has a specific resistance between about 10⁸ to about 10¹² Ωcm.

12. The light emission device of claim 1, wherein each of the fixing blocks is fixed to the first surface of the first substrate by a frit glass adhesive layer.

13. The light emission device of claim 1, wherein the first substrate has a plurality of grooves located at positions corresponding to the fixing blocks, and the fixing blocks are fitted into the grooves.

14. The light emission device of claim 1, further comprising a connection portion for integrally connecting the fixing blocks.

15. The light emission device of claim 1, wherein:
each of the recessed portions has a depth;
each of the cathode electrodes has a first thickness;
each of the electron emission regions has a second thickness; and
the depth is larger than a sum of the first thickness and the second thickness.

16. The light emission device of claim 1, further comprising a plurality of spacers between the electron discharger and the light emitter to withstand a compression force and to maintain the gap between the first surface of the first substrate and the second surface of the second substrate.

17. A display device comprising:
a light emission device for emitting a light; and
a display panel for receiving the light emitted from the light emission device to display images,
the light emission device comprising:
an electron discharger comprising a first substrate, a plurality of cathode electrodes, a plurality of electron emission regions, and a plurality of gate electrodes, the first substrate having a plurality of recessed portions at a first surface of the first substrate, the cathode electrodes extending along a first direction and in the recessed portions, the electron emission regions on the cathode electrodes, and the gate electrodes extending along a second direction crossing the first direction;
a light emitter comprising a second substrate, the second substrate having a second surface facing the first surface of the first substrate with a gap therebetween; and
a plurality of fixing blocks on the first substrate and between the gate electrodes, the fixing blocks being separated from the light emitter.

18. The display device of claim 17, wherein the light emitter further comprises a light emission unit on the second surface of the second substrate and spatially separated from the fixing blocks

19. The display device of claim 18, wherein each of the gate electrodes has a mesh structure with a plurality of openings formed therein.

20. The display device of claim 19, wherein:
the display panel comprises a plurality of first pixels;
the light emission device comprises a plurality of second pixels, the second pixels being less in number than the first pixels; and
each of the second pixels is configured to independently emit light in response to a gray level of corresponding ones of the first pixels.

21. The display device of claim 19, wherein the display panel is a liquid crystal panel.
